(19) United States
(12) Patent Application Publication
(10) Pub. No.: US 2009/0225792 A1
(43) Pub. Date: Sep. 10, 2009

(54) DATA COMMUNICATION SYSTEM AND METHOD

(75) Inventor: Immo Benjes, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,861

(22) PCT Filed: Dec. 5, 2005
(86) PCT No.: PCT/IB2005/054047

§ 371 Date: Jun. 5, 2007

(30) Foreign Application Priority Data
Dec. 8, 2004 (GB) 0426911.4

(51) Int. Cl. H04J 3/02

(52) U.S. Cl. 370/537

(57) ABSTRACT

A communication system comprises a multiplexer and a transmitter. The multiplexer is for receiving a plurality of channels and at least one zapping service. The multiplexer combines the channels and the zapping service(s) into a time sliced signal. The signal comprises time slices each including a burst of one channel and one or more zapping services. The number of zapping services in each time slice is less than the total number of channels, and each zapping service in the time slice is determined by a defined algorithm.

This invention relates to a data communication system and to a method of communication.

In the field of electronic communication, whether via wireless means (such as a mobile phone network or a broadcast television system) or wired means (such as an email system) a structure for the communication system must be agreed. In many cases this will be carried out by an independent body, which will determine such matters as signal design, signal power, modulation scheme and communication protocols, amongst other things. The structure is often referred to as a standard and is named. An example of one such standard is Bluetooth, which is a short range wireless communication standard. Many other standards are well known, such as GSM (Global System for Mobile communications) for mobile telephony and DVB (Digital Video Broadcasting) for digital television.

In the standard DVB-H (DVB for handhelds) the different channels/services (the expressions channels and services are used interchangeably in this document) are transmitted in bursts. For example, if ten channels are being broadcast, then each channel can be transmitted in one burst of one second every ten seconds (it is not necessary that each burst be the same time length, but this is the simplest embodiment).

The primary reason for this scheme being used is that it allows the receiver to shutdown the frontend between the bursts to save battery power. In complicated handheld devices, reducing battery consumption is of great importance. Therefore ten seconds of a channel are compressed into a one second burst, and the receiving device need only supply power to the frontend (tuning and demultiplexing part of the receiver) for one second in every ten.

This technique is used in other battery powered systems as well, for example Bluetooth. The ratio between burst duration (one time slice) and the time between bursts (frame duration), however has to be much higher in the DVB-H system compared with, for example, Bluetooth, as the modulation system used in DVB-H (OFDM—Orthogonal Frequency Division Multiplexing) results in the frontend needing more time (in the area of 0.2-0.5 seconds) to acquire a lock on the signal. This means that the frames in communication systems such as DVB-H tend to be rather long.

Long frames, however, have one major problem. When a user wants to switch to another service the receiver has to wait until the next burst of that service comes along. For example, if the user is tuned to burst one (lasting one second) of a ten second burst and then selects burst nine, then they have to wait up to ten seconds for the receiver to receive the correct time slice. This problem becomes particularly acute if the user is “zapping” between channels, as is common to ascertain the current content of each channel/service.

One known solution to this problem is to provide a “zapping service”, in addition to the normal channels. This service provides, for each channel, appropriate content, that can be shown by the receiver, while the user is waiting for the receiver to retune to the new channel. The content can be a still image, text or possibly low resolution video that is used to mask the delay between the channel switching. In known systems, the zapping channel, containing info (I-Frames, text, audio etc.) for all other services, is accessible within one time slice or the zapping channel is transmitted as an extra service and has to be buffered. In the first of these two systems, a large amount of extra data is needed to be transmitted in each time slice, and in the second of the systems, an entire time slice is lost to the zapping service, with a reduction in the available channels for broadcast, the receiving device must have the capability to buffer an entire time slice, and battery consumption in the receiving device is increased, as the receiving device is required to power up for two individual time slices of the signal, rather than a single time slice.

It is therefore an object of the invention to improve upon the known art.

According to a first aspect of the present invention, there is provided a communication system comprising a multiplexer for receiving a plurality of channels and for receiving at least one zapping service and for multiplexing the channels and the or each zapping service into a time sliced signal, the signal comprising time slices comprising a burst of one channel and one or more zapping services, and a transmitter for transmitting the signal, wherein in each time slice of the signal that includes a zapping service, the number of zapping services in the time slice is less than the total number of channels, and the or each zapping service in the time slice is determined by a defined algorithm.

According to a second aspect of the present invention, there is provided a communication method comprising receiving a plurality of channels, receiving at least one zapping service, multiplexing the channels and the or each zapping service into a time sliced signal, the signal comprising time slices comprising a burst of one channel and one or more zapping services, and transmitting the signal, wherein in each time slice of the signal that includes a zapping service, the number of zapping services in the time slice is less than the total number of channels, and the or each zapping service in the time slice is determined by a defined algorithm.

Owing to the invention, it is possible to minimise the buffering of zapping information and the overhead of transmitting ‘redundant’ zapping information (or at least minimising the amount of data needed for the zapping channel) while minimising the perceived channel switching time.

Preferably, each time slice of the signal includes m−1 zapping services wherein m is an integer factor of the total number of channels. By splitting the number of channels into m blocks and carrying m−1 zapping services in each time slice of the signal, a flexible system is supported, as the choice of the value of m can be selected by the broadcaster according to the balance they wish to strike between bandwidth usage for zapping services, and apparent delay in channel change to the end user.

Advantageously, each time slice of the signal comprises m−1 zapping services, the zapping services comprising those from k=1 to k=m−1 according to the defined algorithm x+(n/m*k) mod n, where x=the channel number of the time slice and n=the total number of channels. This algorithm defines one possible way of selecting which zapping services are to be carried by each time slice of the signal. It provides a simple and efficient way of determining a possible arrangement of the zapping services in the signal.

Ideally, the number of zapping services is equivalent to the number of channels. This provides the simplest arrangement of the zapping services in relation to the number of channels, and ensures that all channels have a zapping service that can by used by the receiving handset to “mask” the apparent delay in obtaining a selected channel.

Embodiments of the present invention will now be described, by way of example only, with reference to the accompanying drawings, in which:

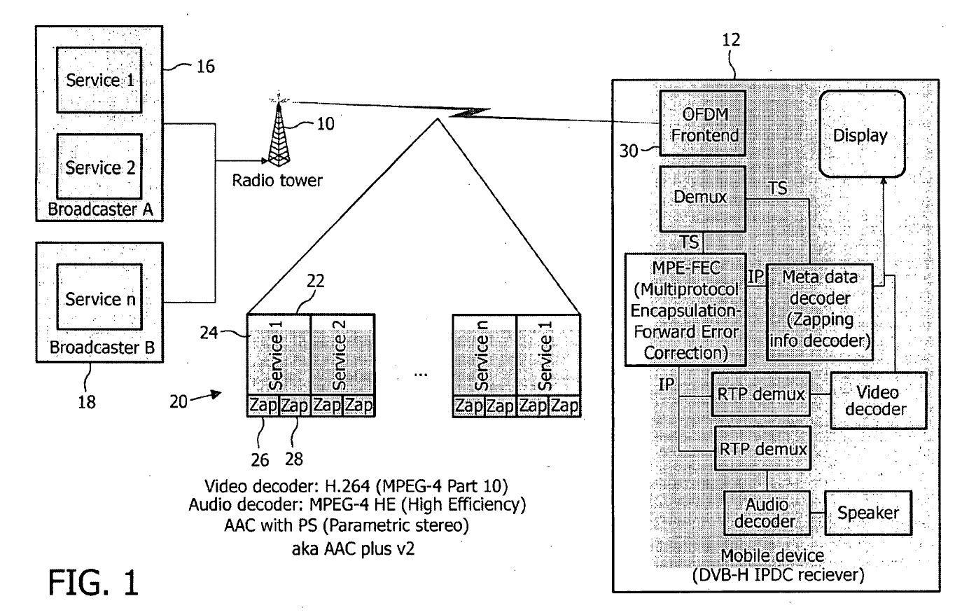

FIG. 1 is a schematic diagram of a communication system,

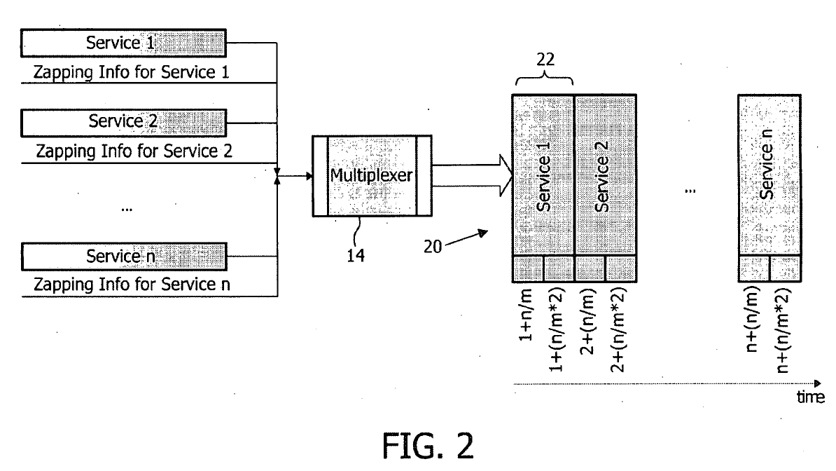

FIG. 2 is a schematic diagram of a multiplexer combining a plurality of channels and zapping services being multiplexed into a signal, and

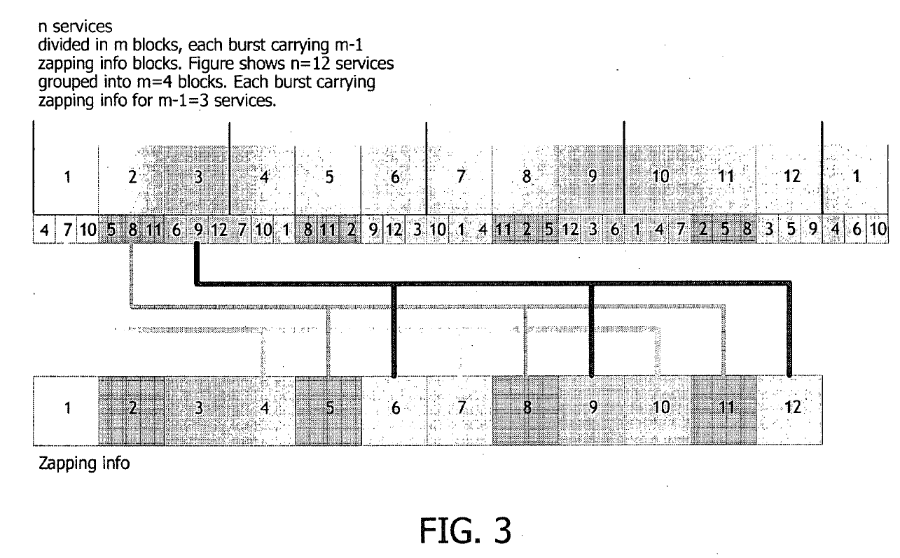

FIG. 3 is a schematic diagram of a signal.

FIG. 1 shows an end to end system for broadcasting services to a user. The principal elements of the communication system are a transmitter 10, a receiver 12 and a multiplexer (which is shown in FIG. 2 as the multiplexer 14). In FIG. 1, two broadcasters 16 and 18 are providing services to be multiplexed together and transmitted by the transmitter 10. The services 1 to n are multiplexed together into a time sliced signal 20. Each time slice 22 of the signal 20 includes a service 24 and two zapping services 26 and 28 for two other channels within the signal 20.

The handset 12 has a number of internal components shown which allow the handset 12 to receive the signal 20 and demultiplex the signal 20 and obtain the service that the user wishes to access. In the normal operation of the handset 12, the user selects, for example service 3, which occupies one second of a ten second time sliced signal. The handset 12 is arranged to power up the OFDM frontend 30 for one second in every ten, which corresponds to the time slice in which the service number 3 is present. However, when the user changes channel, then the OFDM frontend 30 must be powered up at the next available time slice for the new channel that the user has selected.

The ideal system (from the point of the user) would allow for an instant channel change. This would require that information for all zapping services is repeated in every time slice of the signal 20. In an ideal world this information would be a video/audio sequence which would fit seamlessly with the video/audio of the new channel once the time slice for that new service is received. However the bandwidth overhead for this solution is too high. When the zapping info only contains, for example, still frames and or text than the user will be able to identify what is on the channel and decide to stay with this channel or zap away before the next burst is received. It will however still take the normal time until the real service is displayed.

In the communication system of FIGS. 1 and 2, the zapping information is distributed over all of the time slices in such a way that the maximum channel change time and the average channel change time is minimised while keeping the required data rate for the zapping information as low as possible. The channel change time is defined as the time until data about the new channel is received. This may be the live service, or the zapping service carrying text and or a still image.

The worst case scenario for a channel change is a system without any zapping services being carried in the signal. In an example where a user at time 0 (in time slice 1) wants to change to service 9, the delay is t_max=8*t or (n−1)*t, where n is the total number of channels in the signal and t is the average time length of a data slice in the signal. In this scenario, the average channel change time t_avg=(n/2)*t. This equation assumes that when a user switches to service 1 during the burst 1 the receiver will be able to receive at least part of that data in the time slice and will be able to display that data to the user. However, if this is not the case, for example, because an I-Frame was missed, the equation will be t_avg=n*t*(n+1)/(2*(n−1)), and t_max=n*t. In the example of 9 services being carried in the signal, then t_avg=4.5*t (or 5.625*t for the latter case above).

The amount of zapping information per service is d_zap and the overall amount of zapping info per frame is d_all. In a system without any zapping services being carried, d_all=0. At the other extreme, if every time slice is carrying zapping information for all services d_all=n*(n−1)*d_zap, and (n−1)*d_zap is the amount of data which has to be buffered by the receiving device, but in this case t_max and t_avg are both 0. If no buffering is done t_max and t_avg are both t (being the time length of one time slice).

If the zapping info is transmitted as a burst on its own d_all=(n−1)*d_zap, but this data has to be buffered in the receiver to achieve fast channel change and this means that the receiver has to tune in to two bursts in each frame, thus reducing the energy saving achieved by using time slices.

In the communication system described with reference to the drawings, each frame (the portion of the signal that contains all of the services from 1 to n) is divided into m different blocks and only zapping information relating to m−1 services is provided in each burst. The zapping data carried in each burst is for the services which are n/m*k mod n with k=1 to k=m−1 burst away from the service carried in the current burst. The table below shows this in the case of n=9 and m=3.

| 1 | | 2 | | 3 | | 4 | | 5 | | 6 | | 7 | | 8 | | 9 | | 1 | |
|---|---|---|---|---|---|---|---|---|---|---|---|---|---|---|---|---|---|---|---|
| 4 | 7 | 5 | 8 | 6 | 9 | 7 | 1 | 8 | 2 | 9 | 3 | 1 | 4 | 2 | 5 | 3 | 6 | 4 | 7 |

In this table, which effectively shows one frame of 9 time slices of the signal plus one time slice (at the end) of the next frame of the signal, the top line shows the number of the service that is carried in the time slice/burst and the bottom line shows the numbers of the two zapping services carried in that time slice. So, for example, in the first time slice of the frame of the signal, service number 1 is carried in that burst, along with the zapping services for service 4 and 7, which could be, for example, a still image showing what is presently showing on that channel.

For the handset user the critical equations are now as follows: t_max=((n/m)−1)*t (or t*n/m if the handset cannot acquire the service that is current, when instructed to switch to that service). The average channel change time t_avg=((n−m)*n*t)/(2*(n−1)*m) and for the second case (unable to acquire current service) t_avg=(n*(n+m)*t)/((n−1)*2*m). The amount of zapping data d_all=n*(m−1)*d_zap, while the receiver has to buffer only (m−1 )*d_zap. Note that m should be chosen in such a way that n/m is an integer. That means n should not be a prime number, and m should be an integer factor of n.

When the user want to change channel to service 9 during burst 1 the receiver would first wake up to receive burst 3 as this burst contains zapping information for service 9. The receiver would display this information after 2*t (plus any additional decoding time) and switch off the frontend for another 5 slots until the next burst of service 9 arrives.

FIG. 2 illustrates the creation of the signal 20 in more detail. The multiplexer 14 receives channels 1 to n and the corresponding zapping services 1 to n. In the example of this Figure, m has been set to 3, so each time slice 22 of the signal 20 will carry m−1=2 zapping services. As can be seen in FIG. 2, time slice 1 which carries service 1 will carry zapping services for channels 1+(n/m) and 1+((n/m)*2). The general formula for the determination of which zapping service is to be carried by a particular time slice x is x+(n/m*k) mod n {from k=1 to k=m−1}. This defined algorithm provides a simple and efficient method for determining which zapping services are to be carried by any particular time slice.

FIG. 3 shows the construction of a signal for n=12 services and m=4 blocks, which means that every burst carries zapping information for m−1=3 services. As can be seen in the Figure, the first time slice of the signal will carry service 1 and the zapping services for channels 4, 7 and 10. If t=1 second as the length of each time slice and the frame length is 12 seconds, then t_avg=0.703 of a second, assuming that the. receiving device can decode and display a time slice if the user switches to a channel that is at that time being broadcast. The tables below show t_avg, in this situation, for different combinations of m and n.

| | n | | | | | |
|---|---|---|---|---|---|---|
| m | 5 | 6 | 7 | 8 | 9 | 10 |
| 2 | 0.9375 | 1.2 | 1.45833 | 1.71429 | 1.96875 | 2.22222 |
| 3 | 0.41667 | 0.6 | 0.77778 | 0.95238 | 1.125 | 1.2963 |
| 4 | 0.15625 | 0.3 | 0.4375 | 0.57143 | 0.70313 | 0.83333 |
| 5 | 0 | 0.12 | 0.23333 | 0.34286 | 0.45 | 0.55556 |
| 6 | | 0 | 0.09722 | 0.19048 | 0.28125 | 0.37037 |

n

| m | 11 | 12 | 13 | 14 | 15 |
|---|---|---|---|---|---|
| 2 | 2.475 | 2.72727 | 2.97917 | 3.23077 | 3.48214 |
| 3 | 1.46667 | 1.63636 | 1.80556 | 1.97436 | 2.14286 |
| 4 | 0.9625 | 1.09091 | 1.21875 | 1.34615 | 1.47321 |
| 5 | 0.66 | 0.76364 | 0.86667 | 0.96923 | 1.07143 |
| 6 | 0.45833 | 0.54545 | 0.63194 | 0.71795 | 0.80357 |

n

| m | 16 | 17 | 18 | 19 | 20 |
|---|---|---|---|---|---|
| 2 | 3.73333 | 3.98438 | 4.23529 | 4.48611 | 4.73684 |
| 3 | 2.31111 | 2.47917 | 2.64706 | 2.81481 | 2.98246 |
| 4 | 1.6 | 1.72656 | 1.85294 | 1.97917 | 2.10526 |
| 5 | 1.17333 | 1.275 | 1.37647 | 1.47778 | 1.57895 |
| 6 | 0.88889 | 0.97396 | 1.05882 | 1.14352 | 1.22807 |

n

| m | 21 | 22 | 23 | 24 | 25 |
|---|---|---|---|---|---|
| 2 | 4.9875 | 5.2381 | 5.48864 | 5.73913 | 5.98958 |
| 3 | 3.15 | 3.31746 | 3.48485 | 3.65217 | 3.81944 |
| 4 | 2.23125 | 2.35714 | 2.48295 | 2.6087 | 2.73438 |
| 5 | 1.68 | 1.78095 | 1.88182 | 1.98261 | 2.08333 |
| 6 | 1.3125 | 1.39683 | 1.48106 | 1.56522 | 1.64931 |

For the communication system to function, it does not matter how the zapping service(s) is/are actually transmitted and distributed over a time slice. The zapping services can be transmitted in sections or via the IP flow.

The communication system and method can also be used for multiple transponders without modification. However, each transponder only carries zapping information for services in the same transponder. The table below illustrates multiple transponders with the different services and zapping services. The average channel change time is slightly longer than for the one transponder case. This is due to the fact that, for example, when a user changes during burst one from transponder A to service C7 on transponder C, zapping information for C7 isn't carried within burst A1 (as it would be the case when switched to A7). So the receiver has to tune to transponder C and wait for burst 4 to come along as burst 4 carries zapping information for C7. The average channel change time when changing to another transponder is therefore t_avg=((n+m)*t/(2*m).

| A1 | | A2 | | A3 | | A4 | | A5 | | A6 | | A7 | | A8 | | A9 | | A1 | |
|---|---|---|---|---|---|---|---|---|---|---|---|---|---|---|---|---|---|---|---|
| A4 | A7 | A5 | A8 | A6 | A9 | A7 | A1 | A8 | A2 | A9 | A3 | A1 | A4 | A2 | A5 | A3 | A6 | A4 | A7 |
| B1 | | B2 | | B3 | | B4 | | B5 | | B6 | | B7 | | B8 | | B9 | | B1 | |
| B4 | B7 | B5 | B8 | B6 | B9 | B7 | B1 | B8 | B2 | B9 | B3 | B1 | B4 | B2 | B5 | B3 | B6 | B4 | B7 |
| C1 | | C2 | | C3 | | C4 | | C5 | | C6 | | C7 | | C8 | | C9 | | C1 | |
| C4 | C7 | C5 | C8 | C6 | C9 | C7 | C1 | C8 | C2 | C9 | C3 | C1 | C4 | C2 | C5 | C3 | C6 | C4 | C7 |

1. A communication system comprising a multiplexer for receiving a plurality of channels and for receiving at least one zapping service and for multiplexing the channels and the or each zapping service into a time sliced signal, the signal comprising time slices comprising a burst of one channel and one or more zapping services, and a transmitter for transmitting the signal, wherein in each time slice of the signal that includes a zapping service, the number of zapping services in the time slice is less than the total number of channels, and the or each zapping service in the time slice is determined by a defined algorithm.

2. A system according to claim 1, wherein each time slice of the signal includes m−1 zapping services wherein m is an integer factor of the total number of channels.

3. A system according to claim 2, wherein each time slice of the signal comprises m−1 zapping services, the zapping services comprising those from k=1 to k=m−1 according to the defined algorithm x+(n/m*k) mod n, where x=the channel number of the time slice and n=the total number of channels.

4. A system according to claim 1, wherein the number of zapping services is equivalent to the number of channels.

5. A system according to claim 1, further comprising a receiving device for receiving the transmitted signal.

6. A communication method comprising receiving a plurality of channels, receiving at least one zapping service, multiplexing the channels and the or each zapping service into a time sliced signal, the signal comprising time slices comprising a burst of one channel and one or more zapping services, and transmitting the signal, wherein in each time slice of the signal that includes a zapping service, the number of zapping services in the time slice is less than the total number of channels, and the or each zapping service in the time slice is determined by a defined algorithm.

7. A method according to claim 6, wherein each time slice of the signal includes m−1 zapping services wherein m is an integer factor of the total number of channels.

8. A method according to claim 7, wherein each time slice of the signal comprises m−1 zapping services, the zapping services comprising those from k=1 to k=m−1 according to the defined algorithm x+(n/m*k) mod n, where x=the channel number of the time slice and n=the total number of channels.

9. A method according to claim 6, wherein the number of zapping services is equivalent to the number of channels.

10. A method according to claim 6, further comprising receiving the transmitted signal.
